(19) United States
(12) Patent Application Publication
(10) Pub. No.: US 2023/0135997 A1
(43) Pub. Date: May 4, 2023

(54) AI MONITORING AND PROCESSING SYSTEM

(71) Applicant: ACUMINO, Renton, WA (US)

(72) Inventors: Patrick McKinley JARVIS, Redmond, WA (US); Ke WANG, Charlottesville, VA (US)

(21) Appl. No.: 17/978,731

(22) Filed: Nov. 1, 2022

Related U.S. Application Data
(60) Provisional application No. 63/325,338, filed on Mar. 30, 2022.
(60) Provisional application No. 63/274,233, filed on Nov. 1, 2021.

(51) Int. Cl. G06T 7/00; G06F 21/62; G06T 5/00

(52) U.S. Cl. CPC G06T 7/0004; G06F 21/6254; G06T 5/002

(57) ABSTRACT

An Artificial Intelligence (AI) system for monitoring and/or processing a data collection process involving one or more data collection subjects. The AI system includes an AI module. The AI module is configured to instantiate in a computer readable hardware storage device the following: an AI monitoring module that is configured to instantiate the following: a health protocol check submodule configured to check if one or more health safety rules and protocols are being satisfied by the one or more data collection subjects during the data collection process, an environmental condition check submodule configured to check if data collection rules or protocols are being satisfied by the one or more data collection subjects during the data collection process, and an AI processing module configured to remove any PII of the one or more data collection subjects from the data collected during the data collection process.

### CROSS-REFERENCE TO RELATED APPLICATIONS

This application claims the benefit of and priority to U.S. Provisional Patent Application No. 63/274,233, filed on Nov. 1, 2021, and to U.S. Provisional Patent Application No. 63/325,338, filed on Mar. 30, 2022, both of which are incorporated herein by reference in their entirety.

### TECHNICAL FIELD

The disclosure relates to Artificial Intelligence (AI) monitoring and processing systems and methods, in particular, AI monitoring and processing systems and methods for monitoring and processing the collection of data to ensure that collection and health rules are followed, and that personal identification information of the data collection subjects is protected.

### BACKGROUND

There is often a need for the collection of various types of data that can be later used for many purposes. For example, one type of data that is useful to collect is voice data that is collected as different data collection subjects read a prepared story or have a conversation with each other. The collected voice data can then be used to implement or improve voice recognition applications or audio translation applications. Likewise, other types of data about a data collection subject such as facial or other body data may also be collected for use in the implementation or improvement of facial recognition, retinal scan, or figure print applications. Further, other types of data not directly related to the human body may be collected from the data collection subjects such as data about a data collection subject's personal preferences or lifestyle or data about his or her job or educational level. Thus, any type of data may be collected as needed.

As may be appreciated, in order to properly collect the data so that it can be used for its intended purpose, the person or entity that designs the data collection process will specify rules and protocols that need to be followed to ensure that the data is properly collected. In addition, the environment of the location where the data is collected may also need to be controlled so that adverse conditions do not impede the collection of the data.

In some instances, there is often the need for two or more data collection subjects to be in the same location when the data is being collected. For example, two data collection subjects may be involved in a conversation with each other. However, the outbreak of the severe acute respiratory syndrome coronavirus 2 (SARS-COV-2) in 2019, and the ensuing pandemic of 2020, have increased and highlighted the importance of ensuring that health and safety protocols are followed when data collection subjects work within close proximity to each other.

In addition, in recent years there has been an increased emphasis on the need to protect the personal identity of people involved in various activities. In the context of data collection, it may be important to ensure that the identity of the data collection subjects is protected so that the identity is not discoverable by other parties. For example, many governmental entities now have laws that require that all personal identifiable information (PII) be removed so that the data collection subject cannot be identified by access to the collected data. In jurisdictions without such PII laws, the data collection subject may not agree to perform the data collection with PII protections simply because he or she does not wish to be identified from the data or fears such identification could be used for a malicious purpose.

In view of the above, there is a need for an improved AI monitoring system and method for data collection that is able to provide feedback and warnings that ensure the data collection rules and protocols are followed, that health and safety protocols are followed, and that any PII in the collected data is removed.

### SUMMARY

One embodiment disclosed herein provides for an Artificial Intelligence (AI) system for monitoring and/or processing a data collection process involving one or more data collection subjects. The system may include an AI module. The AI module is configured to instantiate in a computer-readable hardware storage device that follows a health protocol check module configured to check if one or more health safety rules and protocols are being satisfied by the one or more data collection subjects during the data collection process, an environmental condition check module configured to check if data collection rules or protocols are being satisfied by the one or more data collection subjects during the data collection process, and a Personal Identification Information (PII) module configured to remove any PII of the one or more data collection subjects from the data collected during the data collection process.

Another embodiment disclosed herein provides for a method for an Artificial Intelligence (AI) system to monitor a data collection process. The method includes sending one or more instructions to one or more data collection subjects, the one or more instructions indicating one or more health safety rules and protocols, and/or one or more data collection rules or protocols that are to be satisfied by one or more data collection subjects during the data collection process, sending a warning message to the one or more data collection subjects when it is determined that the one or more data collection subjects are violating or more of the health safety rules and protocols and/or one or more data collection rules or protocols, and receiving feedback from the one or more data collection subjects that the violation has been corrected.

A further embodiment disclosed herein provides for an AI system for monitoring a data collection process involving one or more data collection subjects. The AI monitoring system includes a monitoring camera configured to measure distances between one or more data collection subjects, one or more data collection devices at a data collection location, and one or more objects of interest, a video communication client configured to access a video communication program or video conferencing platform and to communicate with a video communication program or video conferencing platform of a remote computing system, and a client configured to render the distances measured by the monitoring camera in real-time such that a user of the remote computing system is able to receive real-time input from the data collection location.

A further embodiment makes full use of the capabilities of communication programs or video conferencing platforms. A computing system of a data collection subject at a remote location which can host a communication program or video conferencing platform uses the communication program or video conferencing platform to stream real-time video to a computing system at the location of a data collection coordinator. An AI smart-sensing plugin at the computing system of the data collection coordinator process the incoming streamed data to: 1) detect markers, objects, and people, 2) extract sensor values through a display; perform measurements; and 4) render detection/extraction/measurement results on the video frame and feed this video frame back to the computing system of the data collector using the communication program or video conferencing platform hosted by the computing system of the data collector. This configuration simplifies the preparation and cost of the data collection site as the data collection subject only needs to have a computing system that supports the communication program or video conferencing platform, and the data collection coordinator only needs to send markers and sensors to the data collection subject.

In the embodiments disclosed herein, the different AI modules such as an AI monitoring module, an AI processing module, and an AI smart-sensing plugin module can be placed in a computing system of a data collection subject, or they can be placed in a computing system of a data collection coordinator. In other embodiments, the different AI modules may be placed in the cloud. In still other embodiments, some of the AI modules may be placed in the computing system of the data collection subject and some may be place in the computing system of the data collection coordinator. In further embodiments, some of the AI modules may be placed in a combination of the data collection subjects computing system, the data collection coordinators computing system, and the cloud.

### BRIEF DESCRIPTION OF THE DRAWINGS

These and other features, aspects, and advantages of the present disclosure will become better understood regarding the following description, appended claims, and accompanying drawings.

FIG. 1 is a diagram of an AI monitoring and processing system according to an embodiment of the disclosure.

FIGS. 2A-2C illustrate an operation of an AI monitoring module according to an embodiment of the disclosure.

FIG. 3 is a diagram of an interaction mode between the AI monitoring module and a data collection subject according to an embodiment of the disclosure.

FIGS. 4A-4C illustrate an example embodiment of an interaction between the AI monitoring module and a data collection subject when performing a health protocol check.

FIGS. 5A-5C illustrate an example embodiment of an interaction between the AI monitoring module and a data collection subject when performing an environmental/condition check.

FIG. 6 illustrates an operation of an AI processing module according to an embodiment of the disclosure.

FIGS. 7A and 7B illustrate an example embodiment of the interaction between the AI processing module when performing a PII removal process.

FIG. 8 illustrates a monitoring system that renders a remote collection location in real time.

FIG. 9 illustrates a monitoring system that utilizes the capabilities of communication programs or video conferencing platforms

### DETAILED DESCRIPTION OF VARIOUS EMBODIMENTS

### A. Overview

A better understanding of different embodiments of the disclosure may be had from the following description read with the accompanying drawings in which like reference characters refer to like elements.

While the disclosure is susceptible to various modifications and alternative constructions, certain illustrative embodiments are in the drawings and are described below. It should be understood, however, there is no intention to limit the disclosure to the specific embodiments disclosed, but on the contrary, the intention covers all modifications, alternative constructions, combinations, and equivalents falling within the spirit and scope of the disclosure.

It will be understood that unless a term is expressly defined in this application to possess a described meaning, there is no intent to limit the meaning of such term, either expressly or indirectly, beyond its plain or ordinary meaning.

### B. Various Embodiments and Components for Use Therewith

Artificial Intelligence (AI) monitoring and processing system and method embodiments are described herein. An AI monitoring and processing system and method according to the disclosed embodiments advantageously provides a way for data collection that is able to provide feedback and warnings that ensure that data collection rules and protocols are followed, that health and safety protocols are followed, and that any PII in the collected data is removed. The system and method can operate in substantially real-time, and the system may monitor the collection of the data by processing one or more captured images locally or remotely.

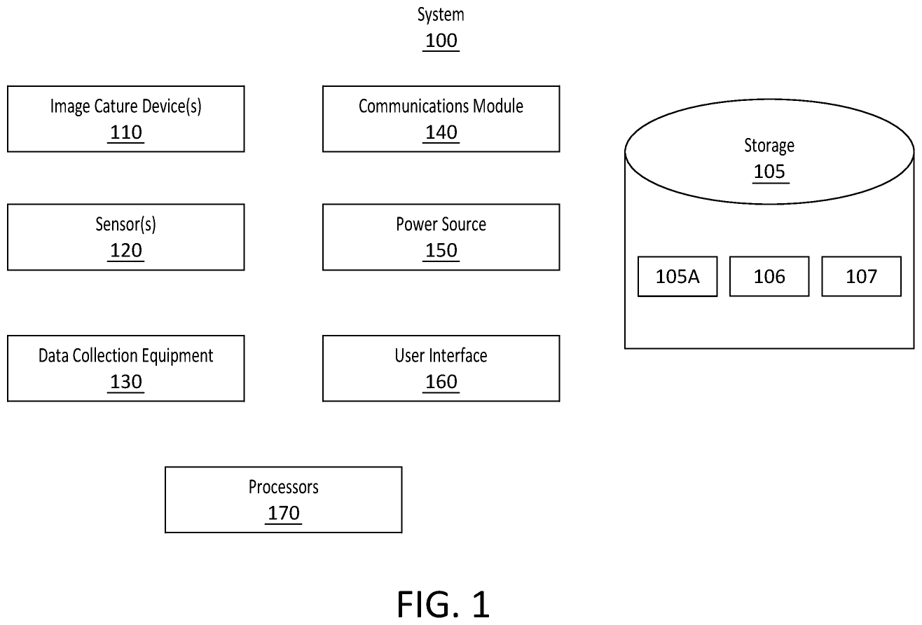

FIG. 1 is a diagram of an AI monitoring and processing system 100 (hereinafter also referred to simply as “system 100) according to an embodiment of the present disclosure. The system 100 may include one or more image capture devices 110. The one or more image capture devices 110 may be any suitable image capture device, such as a digital camera configured for capturing one or more images or one or more videos, each video comprising a plurality of frames. In one embodiment, the one or more image capture devices 110 may be a 3D depth camera configured to use range imaging to capture the distance to points in a scene to thereby generate images in 3D. Accordingly, the embodiments disclosed herein are not limited to any particular type of image capture device.

The one or more image capture devices 110 may be configured with an attachment component so as to be mountable in any suitable position to any suitable surface such as a wall, desk, or ceiling. The attachment component may be any suitable component, such as hardware components including a wall or ceiling mount that can attach using one or more screws or other components. The attachment component may comprise one or more lockable joints cooperating with one or more body segments that allow the camera to be pivoted or swiveled to a desired position. For example, the one or more lockable joints can be unlocked to pivot the attachment component such that the camera 110 points toward towards a data collection subject and the objects surrounding the data collection subject.

In embodiments, the system 100 may comprise one or more sensors 120. The one or more sensors 120 may be mounted on suitable surfaces, such as a wall, ceiling, or otherwise that allow for the sensors to monitor the data collection subject. For example, in some embodiments a sensor 120 may be an infrared temperature sensor that monitors the temperature of the data collection subject or data collection subjects. In other embodiments, a sensor 120 may be a sensor that monitors physical properties of the location or other health properties of the data collection subject or data collection subjects. Accordingly, the embodiments disclosed herein are not limited to any number of sensors 120 or by any type of sensors 120.

In some embodiments, the sensor 120 may be a location determination sensor that is configured to monitor and ascertain the location of the system 100 during the data collection process. For example, the location determination sensor 120 may be, but is not limited to, a GPS sensor that is able to ascertain the location, a Bluetooth sensor that connects to a device such as a cell phone of a data collection subject that has a GPS sensor that is able to ascertain the location, or a sensor with Wi-Fi capability that is able to ascertain the location from the Internet or other network. Thus, in such embodiments the location of the data collection process can be monitored to ensure that the data collection process happens in a desired location. For example, the entity overseeing the data collection process may desire for the data collection process to occur in the North-East of the United States. The use of the location determination sensor 120 allows for monitoring to ensure that the data collection process occurs in the North-East of the United States. In some embodiments, permission from the data collection subjects will be obtained before the location is monitored so as to comply with applicable privacy rules in the location where the data collection process occurs.

In embodiments, the system 100 may comprise various data collection equipment 130. For example, the data collection equipment 130 may include a microphone, a computer such as a laptop computer, speakers, tablet computing systems, visual displays, and the like for collecting and recording various types of data or for providing the data to the data collection subject. The data collection equipment 130 may also include various types of light sources that ensure that the data collection process is able to occur.

In embodiments, the one or more image capture devices, 110, the sensors 120, and the data collection equipment 130 may be operatively connected to each other by a communication module 140, which may be any suitable connection modality, including a wired connection or a wireless connection. The communication module 140 may deliver the captured images from the one or more image capture devices 110, and/or detection signals from the sensors 120 and/or to the data collection equipment 130.

A power source 150 may be provided for the one or more image capture devices 110, the sensors 120, the data collection equipment 130, the communication module 140, and/or a user interface 160, and may comprise a battery power source or a wired connection to an existing power source, such as a power outlet in a restroom facility.

The user interface 160 may comprise any suitable user interface for communicating with the data collection subject. In embodiments, the user interface 160 may comprise an electronic display such as an electroluminescent (ELD) display, a liquid crystal display (LCD), a light emitting diode (LED) display, a plasma display, a quantum dot display, a touch screen such as a resistive touch screen, a surface capacitive touch screen, a projected capacitive touch screen, a surface acoustic wave (SAW) touch screen, an infrared (IR) touch screen, or any other suitable electronic display. The user interface 160 may comprise one or more user input options or modalities, such as buttons or a keyboard, which allow the data collection subject to input information such as identification information.

The user interface 160 may be configured to display instructions to the data collection subject that indicates how the data collection should proceed. The user interface 160 may also be configured to provide warnings to the data collection subject when the instructions have not been properly followed or when a health or safety violation has occurred. The user interface 160 may also be configured to provide feedback to the data collection subject and to allow the data collection subject to provide feedback to the system 100.

In one embodiment, the instructions, the warnings, and/or the feedback that are provided to the data collection subject via the user interface 160 come from or are controlled by an AI module as will be explained in more detail to follow. In another embodiment, the instructions, the warnings, and/or the feedback that are provided to the data collection subject via the user interface 160 come from or are controlled by a data collection coordinator using a video conferencing application associated with the user as will also be explained in more detail to follow. In still a further embodiment, the instructions, the warnings, and/or the feedback that are provided to the data collection subject via the user interface 160 may come from or are controlled from the AI module and/or the data collection coordinator.

The system 100 may comprise a non-transitory computer-accessible or computer-readable storage medium or storage 105 including instructions 105A stored thereon in a non-transitory form for operating the AI monitoring and processing system and a method according to the embodiments described herein. The instructions 105A, when executed, can cause one or more processors 170 to conduct one or more of the steps described herein, and to utilize an artificial intelligence module instantiated in the one or more processors 170 to determine whether the health protocols have been properly followed and the data collection environments/conditions are properly configured as will be explained in more detail to follow.

The storage 105 may also store one or more data collection rules or protocols 106 that are configured to define how an optimum process for collecting the data. For example, in the case of a data collection process for collecting voice data from the data collection subject, the data collection rules or protocols 106 may define a desired distance between a microphone or other equipment 130 and the data collection subject, a desired light condition for the location, or other desired data collection parameters. In some embodiments, the data collection rules or protocols 106 may be entered into the storage 105 by the organization or entity that is hosting the data collection process using a non-illustrated interface or connection.

The storage 105 may also store one or more health safety rules and protocols 107 that are configured to specify certain health rules that should be followed to ensure that the data collection process is safe for the data collection subjects. For example, the health safety rules and protocols 107 may specify that two or more data collection subjects should maintain a social distance of six feet or that they should wear a mask to prevent the spread of COVID-19. In some embodiments, the health safety rules and protocols 107 may be entered into the storage 105 by the organization or entity that is hosting the data collection process using a non-illustrated interface. In still other embodiments, the health safety rules and protocols 107 may be obtained from a public health organization such as the World Health Organization (WHO) or the Centers for Disease Control (CDC).

The system 100 may be configured to provide feedback to the data collection subject through the user interface 160. The feedback may comprise a message or warning that one or more of the health and safety rules and protocols 107 have been violated such as a data collection subject is too close to another data collection subject or is not wearing his or her mask. The feedback may also comprise a message that indicating the collection rules or protocols 106 and if something needs to be changed in order to comply with these. For example, the message may indicate that the light source needs to be turned up or that the microphone needs to move closer to the data collection subject so that data collection can be optimized.

The system 100 may analyze the captured images for improving the privacy and security of the image capture and assessment process to ensure that the data collection subjects PII is removed. For example, the system 100 may be configured to identify and blur or remove human faces from at least one frame of a plurality of frames of a captured video. The system 100 may also be configured to alter any recorded voice data so that is unrecognizable as coming from a given data collection subject or to blur any identifiable text that could be used to identify the data collection subject and/or the location of the data collection process.

As mentioned, the processor 170 may instantiate an artificial intelligence module such as an AI monitoring module 210, an AI processing module 610, and/or an AI smart-sensing plugin module 835 or 935. The artificial intelligence module may comprise one or more computer vision algorithms configured to train and/or apply, for example, a machine learning model and/or a statistical algorithm for determining static features of video frames, human faces in video frames, and to assess the ideal configuration and duration of the data collection process. The machine learning model and/or the statistical algorithm may be trained before the system 100 is deployed and/or may continue to be trained upon successive users of the system 100.

The artificial intelligence module may further advantageously obtain and/or determine a set of metrics generated from the data collection process. The set of metrics may comprise in embodiments an amount of time spent on each step of the procedure. The set of metrics may be used to train the artificial intelligence module to determine a duration and configuration of steps that can reliably lead to an optimum data collection process. The analysis may be done in real-time or after a delay, and may be performed locally or remotely as suitable.

The artificial intelligence module may identify and track a data collection subject, using a computer vision modality, such as a facial detection module, a pose estimation module, an object detection module, an object classification module, an object identification module, an object verification module, an object landmark detection module, an object segmentation module, a tracking module, a video annotation module, or any other suitable AI modality.

In embodiments, the facial detection module and/or object detection and classification modules may be used to identify and blur or remove static features and/or human faces or any other suitable parts of an image. The system may advantageously store the captured images and/or videos on the storage medium in the edited form, thereby excluding that any permanent image of a user's face or any other private or sensitive imagery is stored on the system.

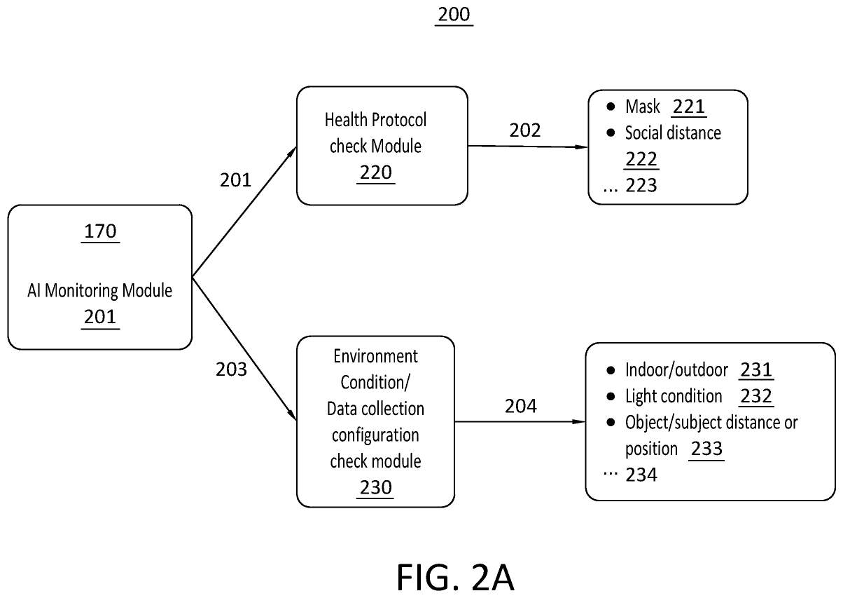

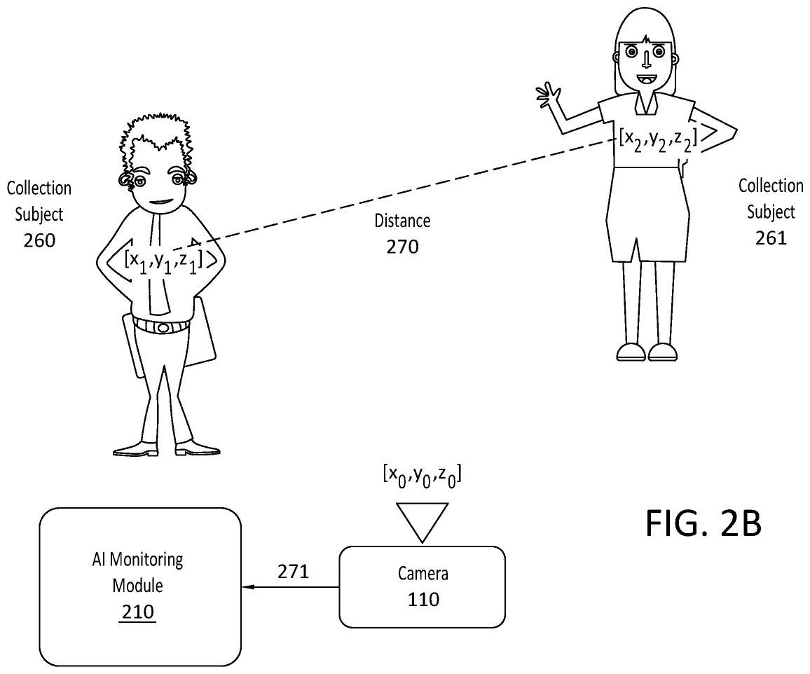

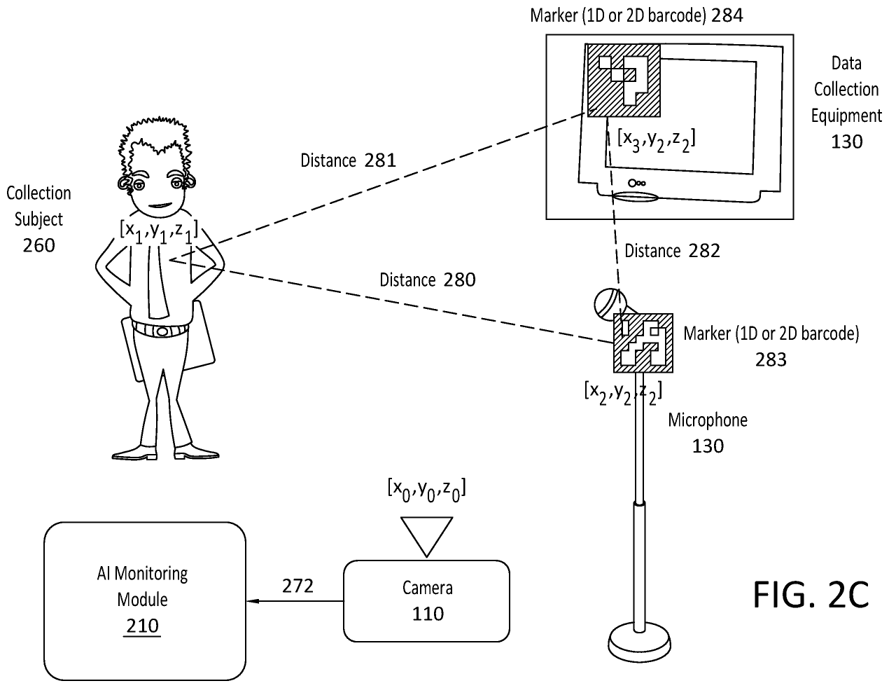

FIG. 2A illustrates an embodiment 200 of the operation of AI monitoring and processing system 100. As shown in the figure, the processor 170 instantiates an AI monitoring module 210 that performs various AI modalities and which may be considered an example of an AI module of an AI system. For example, as shown at 201, the AI monitoring module 210 is configured to operate as a health protocol check module 220 that performs a health and safety protocol check, and which can be considered a submodule of the AI monitoring module 210. The AI monitoring module 210 may use one or more of the image capture devices 110, the sensors 120, and the data collection equipment 130 to check if one or more of the health and safety rules and protocols 107 are being followed by a data collection subject 250 during a data collection process. In the embodiment, as shown at 202, the health protocol check module 220 may check if the data collection subjects are wearing a mask as shown at 221, may check if the data collection subjects are maintaining a proper social distance as shown at 222, and may check if any number of additional health protocols are being followed as illustrated by the ellipses 223. The other health protocol checks 223 may include, but are not limited to a temperature check or a check to see if the data collection subjects are coughing or are congested.

FIG. 2B illustrates the operation of the AI monitoring module 210 when determining a social distance 270 between a collection subject 260 and a collection subject 261. It will be appreciated that the distance 270 may be a specific distance, such as six feet, or it may be an acceptable range, such as 5-7 feet. As shown, the image detection device 110, which in the embodiment is a 3D depth camera, is located near a center or zero location in an X,Y,Z coordinate system. The camera 110 measures a first distance from the camera to the collection subject 260, who in the embodiment is located at location X₁, Y₁, Z₁ in the X,Y,Z coordinate system. The camera also measures a second distance from the camera to a collection subject 261, who in the embodiment is located at location X₂, Y₂, Z₂ in the X,Y,Z coordinate system.

During operation, the 3D depth camera 110 collects data at multiple points on the data collection subject 260 and 261, by for example, using multiple light sensors of the camera to capture the multiple points on the data collection subjects. This collected data in then provided to the AI monitoring module 210 as shown at 271.

The AI monitoring module 210 uses various AI modalities to determine an average of the distance 270 between the data collection subjects 260 and 261. For example, the average distance can be determined by adding the total of the collected points and then diving by the total. Alternatively, a median can be determined so as to remove any points that do not appear to be valid due to a bad reading, sensor, or the like. The average distance may be determined in other ways. As will be explained in more detail to follow, the AI monitoring module 210 is then able to determine if the distance 270 satisfies a distance specified by a health protocol 107 as being acceptable.

In some embodiments, the data collection subjects 260 and 261 may have a marker (unillustrated) attached to them that is used by the camera 110 for focusing where to collect the data points. However, in many instances the data collection subjects 260 and 261 may not desire to have such marker attached to them. Accordingly, in such embodiments the AI monitoring module 210 may perform various body segmentation techniques on the data points collected by the camera 110 using nodes that extend between the body parts of the data collection subjects. Such techniques allow the AI module to focus on the desired parts of the data collection subjects. For example, in some embodiments the camera 110 may be able to collect data from the entire body the data collection subjects. In other embodiments, for example where only the upper half of the body or the face are detectable, then the collection points may focus on only the upper half of the body or on the face. Accordingly, the distance between the center of the faces of the data collection subjects, the distance between the center of the upper portion of the bodies of the data collection subjects, or the distance between the center of the entire bodies of the data collection subjects may be determined.

Returning to FIG. 2A, as shown at 203, the AI monitoring module is also configured to operate as an environmental condition and/or data collection configuration 230 that is configured to perform an environmental/condition check, and which can be considered a submodule of the AI monitoring module 210. The AI monitoring module 210 may use one or more of the image capture devices 110, the sensors 120, and the data collection equipment 130 to check if one or more of the data collections rules or protocols 106 are being followed during the data collection process. In the embodiment, as shown at 204, the environmental condition and/or data collection configuration check module 230 may check if the data collection process is being performed indoors or outdoors as shown at 231, may check the lighting condition of the location where the data collection process is occurring as shown at 232, may check the distance or position between one or more of the data collection equipment 130 like a microphone and the data collection subject as shown at 233, and may check if any number of additional data collection rules or protocols are being followed as illustrated by the ellipses 234. The other collection rules or protocols 224 may include, but are not limited to, placement of one or more of the data collection equipment 130 in the location of the data collection process, the temperature of the location of the data collection process, the sound conditions, and the ability to measure the environment noise levels in the location of the data collection process, and if there is enough or the right kind of data collection equipment 140 present during the data collection process. Although shown as one module, in some embodiments the environmental condition and/or data collection configuration check module 230 may be a configured as a separate environment condition check module and a separate data collection configuration check module, both of which may be considered as submodules of the AI monitoring module 210.

FIG. 2C illustrates the operation of the AI monitoring module 210 when determining a distance 280 between a collection subject 260 and a microphone, which is an example of data collection equipment 130 and also a distance 281 between the data collection subject 260 and another piece of data collection equipment 130. It will be appreciated that the distances 280 and 281 may be a specific distance, such as six feet, or it may be an acceptable range, such as 5-7 feet. As shown, the image detection device 110, which in the embodiment is a 3D depth camera, is located at a center or zero location in an X,Y,Z coordinate system. The camera 110 measures a first distance from the camera to the collection subject 260, who in the embodiment is located at location X₁, Y₁, Z₁ in the X,Y,Z coordinate system. The camera also measures a second distance from the camera to the microphone 130, which in the embodiment is located at location X₂, Y₂, Z₂ in the X,Y,Z coordinate system. The camera also measures a third distance from the camera to the data collection equipment 130, which in the embodiment is located at location X₃, Y₃, Z₃ in the X,Y,Z coordinate system.

During operation, the 3D depth camera 110 collects data at multiple points on the data collection subject 260, the microphone 130, and the other data collection equipment 130, by for example, using multiple light sensors of the camera to capture the multiple points. This collected data in then provided to the AI monitoring module 210 as shown at 272.

As shown in the figure, the microphone 130 includes a marker 283 and the other data collection equipment 130 includes a marker 284. In embodiments, the markers 283 and 284 may be 1D or 2D barcodes or QR codes, or any other suitable type of marker. The camera 110 uses the markers 283 and 284 when measuring the distance between the camera and the microphone 130 and the camera and the other data collection equipment 130. As explained in relation to FIG. 2B, the data collection subject 260 is unlikely to have any marker and so the AI monitoring module 210 may perform various body segmentation techniques on the data points collected by the camera. However, in some embodiments the data collection subject 260 will place a marker on himself or herself and such maker can be used by the cameral 110 when determining the distance between the data collection subject 260 and the microphone 130 and/or the data collection equipment 130.

The AI monitoring module 210 uses various AI modality to determine an average of the distance 280 between the collection subject 260 and the microphone 130. In addition, the AI monitoring module 210 uses various AI modality to determine an average of the distance 281 between the collection subject 260 and the other data collection equipment 130. Further, the AI monitoring module 210 uses various AI modality to determine an average of the distance 283 between the microphone 130 and the other data collection equipment 130. For example, the average distance can be determined by adding the total of the collected points and then diving by the total. Alternatively, other robust average or statistical calculations, such as a median calculation, can also be determined so as to remove or at least minimize the effects of any outlier points that do not appear to be valid due to a bad reading, sensor, or the like. These average distances may be determined using other reasonable average and other statistical calculations. As will be explained in more detail to follow, the AI monitoring module 210 is then able to use the distances between the data collection subject 260 and the microphone 130 or the other data collection equipment 130 or the distance between the microphone 130 and the other data collection equipment 130 to determine if an environmental/condition has been satisfied.

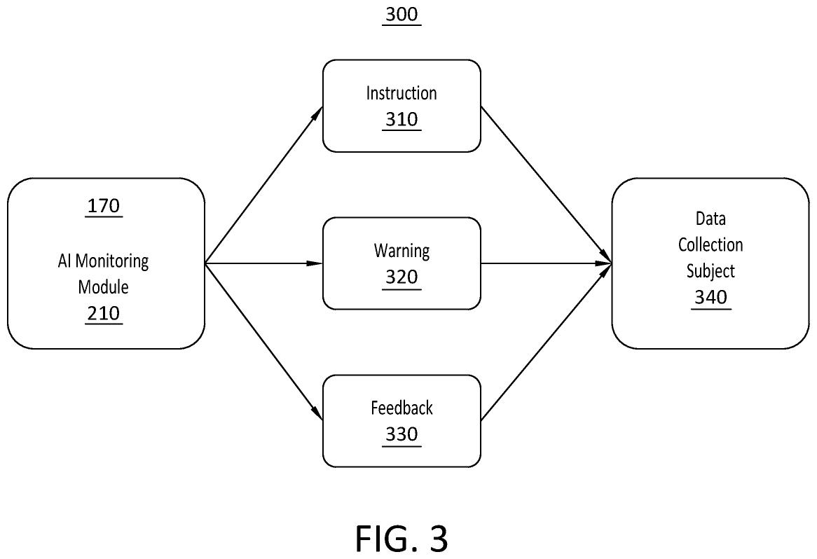

FIG. 3 illustrates an embodiment 300 of an interaction between the AI monitoring module 210 and a data collection subject 340, who may correspond to the data collection subject 260 or 261. As illustrated, the AI monitoring module 210 is able to cause the system 100 to provide an instruction 310 to the data collection subject 340. In one embodiment, the instruction 310 may instruct the data collection subject 340 about the rules and protocols that should be followed during the data collection process. As described above, these rules and protocols may be specified by the data collection rules or protocols 106. For example, in the embodiment the instruction 310 may instruct the data collection subject 340 that a microphone for voice collection should be placed at a desired distance from the data collection subject so as to optimize the voice collection.

In another embodiment, the instruction 310 may instruct the data collection subject 340 about the health safety rules and protocols that should be followed during the data collection process. As described above, these rules and protocols may be specified by the health safety rules and protocols 107. For example, in the embodiment the instruction 310 may instruct the data collection subject 340 that proper social distancing should be maintained whenever another data collection subject is in the same location.

After receiving the instruction 310, the data collection subject 340 is able to use the user interface 160 to provide feedback 330 to the system 100 indicating that the instruction 310 is understood. For example, the data collection subject 340 may provide feedback 330 that indicates that he or she has placed the microphone at the desired location or that he or she will maintain proper social distancing when needed.

The AI monitoring module 210 is also able to cause that the system 100 to provide a warning 320 when one of the data collections rules and protocols and/or one of the health and safety rules and protocols have not been followed. For example, in one embodiment if the data collection subject 340 has moved the microphone too close to him or her, then the system 100 may provide the warning 320 that indicates that the microphone is needs to be moved to the desired distance. In another embodiment, the system 100 may provide a warning 320 that the data collection subject 340 is too close to another data collection subject and thus has not maintained proper social distancing. In still other embodiments, the system 100 may provide both a warning 320 that indicates the microphone needs to be moved to a desired distance and a warning 320 that indicates that data collection subject 340 has not maintained proper social distancing.

After receiving the warning 320, the data collection subject 340 may provide feedback 330 indicating that the cause of the warning 320 has been corrected. In some embodiments, this may be done by providing feedback using the user interface 160. In other embodiments, this may be done automatically by the action of the data collection subject 340. For example, in the embodiment where the warning 320 indicates that the microphone is too close, the action of the data collection subject 340 in moving the microphone to the desired distance may be considered feedback 330 by the system 100.

This process of sending instructions 310 and/or warnings 320 and receiving feedback 330 may be repeated as often as needed. It will be appreciated that although FIG. 3 shows the warning 320 as being separate from the instruction 310, this is for ease of illustration only since the warning is a specific type of instruction. Accordingly, it will be appreciated that the warning 320 is actually a subset of the instruction 310.

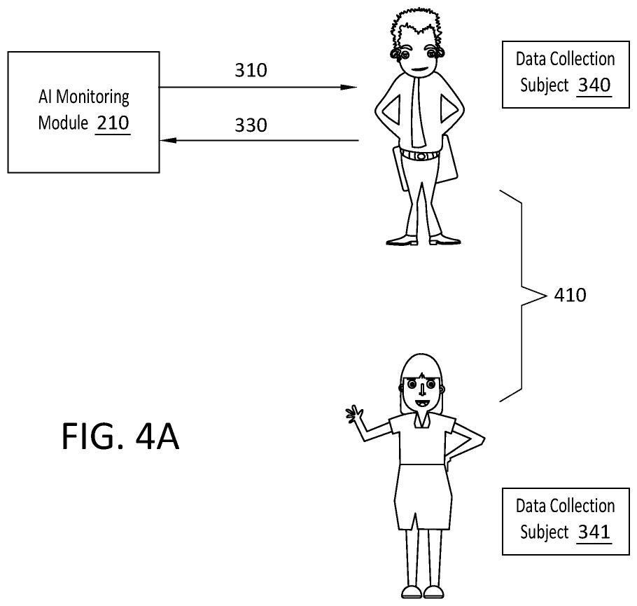

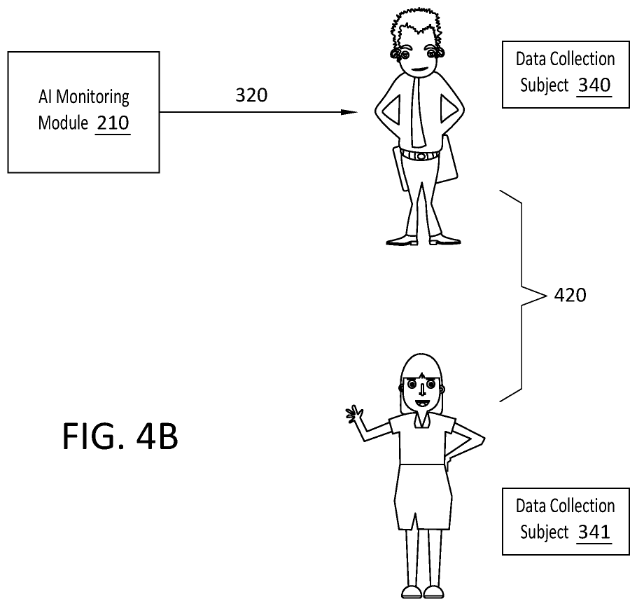

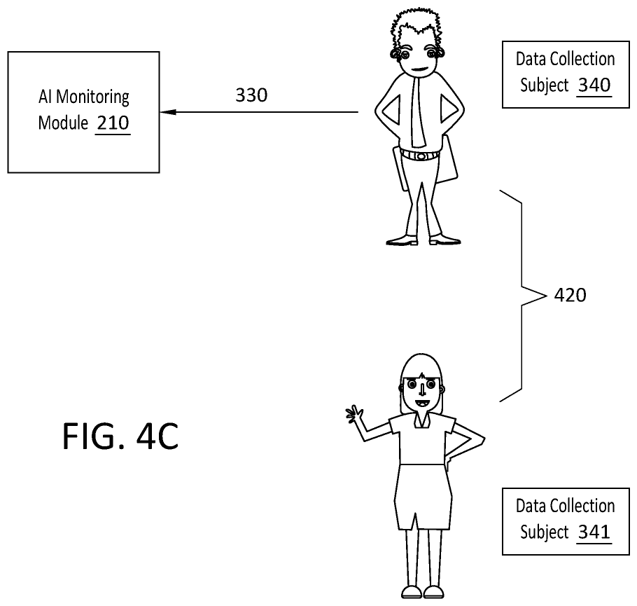

FIGS. 4A-4C illustrate a use case example of the interaction between the system 100 including the AI monitoring module 210 and a data collection subject 340 when preforming a health protocol check during a data collection process. As shown in FIG. 4A, a data collection process is being performed where data is collected from the data collection subject 340 and a second data collection subject 341 at the same location. The data collection subject 340 may receive an instruction 310 from the system 100 specifying that the data collection subject 340 should maintain a proper social distance 410 from the data collection subject 341. The data collection subject 340 may provide feedback 330 indicating that he or she understands using the user interface 160. Thus, as shown in the figure, the data collection subjects are shown as being separated by the proper social distance 410. Although not illustrated, in some embodiments the data collection subject 341 may also receive an instruction 310 in the same manner as the data collection subject 340.

In some embodiments, the feedback 330 from the data collection subject 340 may be a voice input, pressing one or more buttons on a keyboard, using an attached mouse, or other reasonable input. In some embodiments, feedback 330 from the data collection subject 340 may be in the form of a preprinted maker such as an Aruco marker or a QR code. In such embodiments, the data collection subject 340 would hold up the preprinted maker to a camera to indicate that he or she understood the instructions. In some embodiments, the feedback 330 may be used in a flow control process. Thus, once the data collection subject 340 has followed the first step in a particular instruction, he or she may input a voice command, press a button on the keyboard, use the computer mouse, or show the marker to indicate that the first step is complete. The user would then move onto the second step and would again input a voice command, press a button on the keyboard, use the computer mouse, or show the marker to indicate that the second step is complete. This process could be continued until the instruction was completed.

FIG. 4B shows that the data collection subject 340 and the data collection subject 341 have moved closer to each other so that they are separated by a distance 420, which is closer than the proper social distance 410. Accordingly, the system 100 may send a warning 320 to the data collection subject 340 indicating that he or she is too close to the data collection subject 340 and that he or she needs to move back to the proper social distance 410. Although not illustrated, in some embodiments the data collection subject 341 may also receive a warning 320 in the same manner as the data collection subject 340.

FIG. 4C shows that the data collection subject 340 and the data collection subject 341 have moved so that they are again separated by the proper social distance 410. The data collection subject 340 may provide feedback 330 using the user interface 160 indicating that he or she is again separated from the data collection subject 341 by the proper social distance. As discussed above, the feedback 330 may alternatively be automatic based on the fact that the data collection subject moved in response to the warning 320. Although not illustrated, in some embodiments the data collection subject 341 may also provide feedback 330 in response to the warning 320 in the same manner as the data collection subject 340.

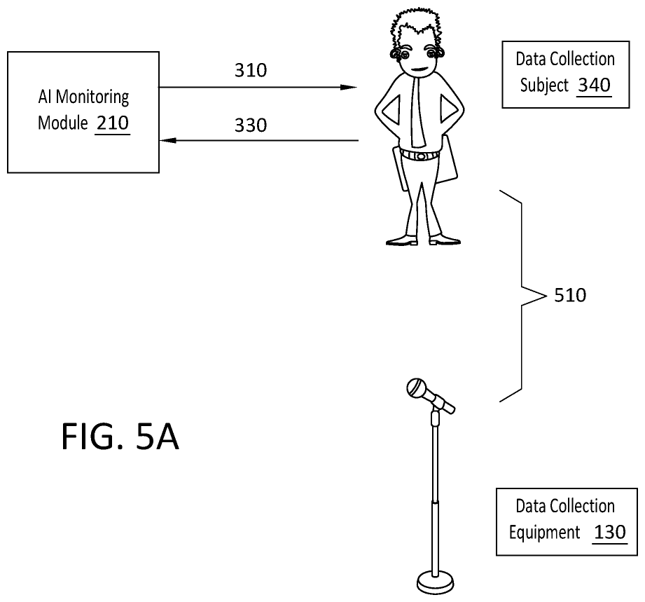

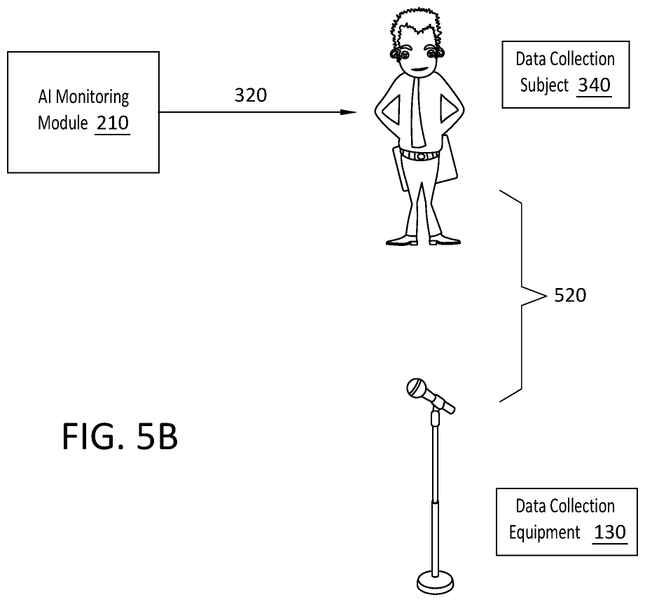

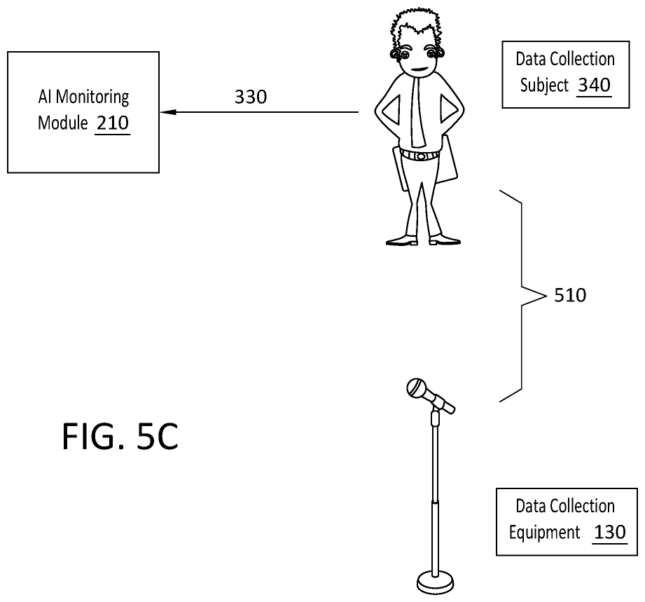

FIGS. 5A-5C illustrate a use case example of the interaction between the AI monitoring system 100 including the AI monitoring module 210 and a data collection subject 340 when performing an environmental/condition check. As shown in FIG. 5A, a data collection process is being performed where data is collected from the data collection subject 340 using a specific data collection equipment 130 such as a microphone for collecting voice data. The data collection subject 340 may receive an instruction 310 from the system 100 specifying that the data collection equipment 140 should be located at a location or distance 510 in relation to the data collection subject so that the data may be optimally collected. The data collection subject 340 may provide feedback 330 indicating that he or she understands. Thus, as shown in the figure, the data collection equipment 130 is located at the location or distance 510.

FIG. 5B shows that the data collection equipment 130 has moved to a different location or distance 520 relative to the data collection subject 340 which is different from the location or distance 510. Accordingly, the system 100 may send a warning 320 to the data collection subject 340 indicating that he or she needs to move or alternatively needs to move the data collection equipment 130 so that the location or distance 510 is maintained.

FIG. 5C shows that the data collection equipment 130 is again located at the location or distance 510 in relation to the data collection subject. The data collection subject 340 may provide feedback 330 indicating this using the user interface 160. As discussed above, the feedback 330 may alternatively be automatic based on the fact that the data collection subject moved or moved the data collection equipment 130 in response to the warning 320.

The embodiments discussed in relation to FIGS. 3-5 discussed use cases where the data collection subject received the warning 320 that the specified distance or range of distances was violated. As discussed, this led to at least one of the data collection subjects moving so the specified distance or range of distances was again maintained. It will be appreciated that the system 100 may also monitor the distances (i.e., distance 270, 280, 281, 410, 510) even in cases where there is no violation of the specified distance. In addition, the system 100 may monitor the other health and safety protocols such as mask wearing 221 and other environment condition checks such as indoor/outdoor 231 and light condition 232 even in cases where there is no violation of these protocols. In such embodiments, the system 100 may record or store the monitored data in the storage 105 or some other storage. For example, if the data collection subject 260 and the data collection subject 261 remain within a specified distance 270 or range of distances 270, the system records this in the storage 105. In this way, it is possible to maintain a record that the various health and safety protocols 107 and the data collection rules or protocols 106 were followed during the data collection process.

In other embodiments, details about the location of the data collection process may be recorded or stored in the storage 105. In addition, details about the data collection subjects such as their age, their gender, or where they live may also be recorded or stored in the storage 105. In this way, a record of who participated on the data collection process and where the data collection process occurred may be kept for later statistical analysis of the data collection process and to ensure that a broad range of data collection subjects participated in the data collection process.

In some embodiments, the data collected during the data collection process may need to be stored, for example in storage 105. In such embodiments, there is a risk that the stored data may include personal identifiable information (PII) such as facial, voice, or other body related PII information or textual related PII that may become known. Accordingly, the AI monitoring and processing system 100 is configured to provide processing of the collected data to remove, to blur, or to otherwise alter any collected PII. In some embodiments, the processing of the collected data to remove, to blur, or to otherwise alter any collected PII may occur onsite (i.e., at the location of the data collection process). Providing the onsite processing of the data collected during the data collection process means that the processing of the collected data to remove, to blur, or to otherwise alter any collected PII happens before the data is stored in the storage 105 or is sent to an offsite data storage. Thus, if the storage 105 (or other storge storing the collected data) is later hacked or otherwise accessed in an unauthorized manner, the stored data should not include any PII as this will have already been removed, blurred, otherwise altered, thus providing enhanced security to the stored collected data. In other embodiments, the processing of the collected data to remove, to blur, or to otherwise alter any collected PII may occur at the storage 105 or it may occur at some location or time in the data collection process. Thus, the embodiments disclosed herein contemplate both onsite and non-onsite processing of the collected data to remove, to blur, or to otherwise alter any collected PII.

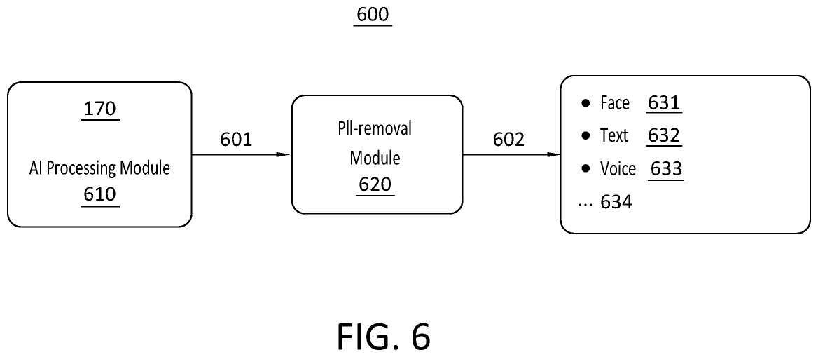

FIG. 6 illustrates an embodiment 600 of the operation of AI monitoring and processing system 100 when operating to remove or to hide any collected PII. As shown in the figure, the processor 170 instantiates the AI processing module 610 that performs various AI modalities, and which may be instantiated in the processor 170 and may be considered an example of an AI module of an AI system. The AI processing module may be considered a submodule of another AI module in some embodiments. For example, as shown at 601, the AI processing module 610 is configured to operate as a PII removal module 620 that removes, blurs, or otherwise alters any collected PII.

As shown at 602, the AI processing module 610 is configured to cause the system 100 to perform PII removal. In the embodiment, as shown at 602, the AI processing module 610 blurs or removes facial features as shown at 631, blurs or removes any textual data that includes PII as shown at 632, blurs, removes or alters voice data so that the source is not recognized as shown at 633, and blurs or removes any additional PII as illustrated by the ellipses 634. The other PII 634 may include, but is not limited to, tattoos, birth marks, or other identifying body features. In addition, AI processing module 610 is able to blur, remove, or otherwise alter any features in the location where the data collection process occurs that may not be considered PII. For example, there may be a desire to blur, remove, or otherwise alter the background of an image so as to focus on the data collection subject or to blur, remove, or otherwise alter furniture, wall pictures, books, or the like that could be used to identify the location of the data collection process. Accordingly, the embodiments disclosed herein allow flexibility for the system to blur, remove, or otherwise alter any features of the capture images, whether the features include PII or non-PII features.

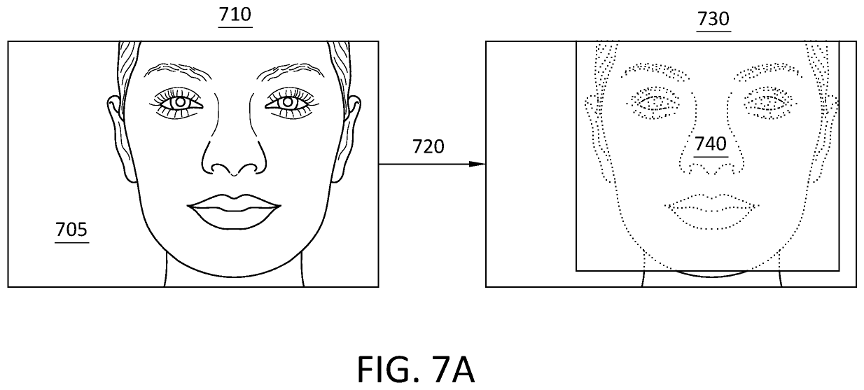

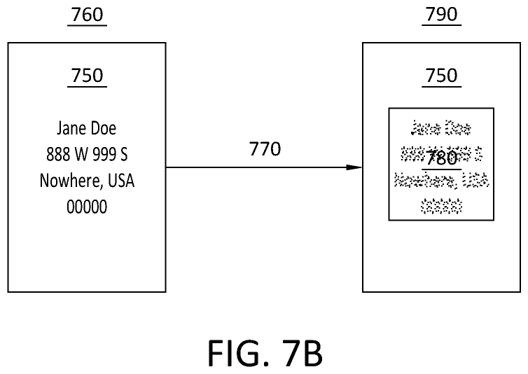

FIG. 7A illustrates a use case of the AI processing module 610 performing PII removal. As illustrated on the left side of FIG. 7A at 710, during the data collection process the one or more image capture devices 110 may record the facial features of a data collection subject 705, who may correspond to the data collection subjects previously discussed. To ensure that any such PII is removed from the captured images, the AI processing module 610 may cause the system 100 to perform the PII removal process as shown at 720. This results in the blurring or removal 740 of the facial features as shown at 730. In other embodiments, it may be desirable to keep the face of the data collection subject shown, as this may be helpful when collecting voice data, while blurring the background so as to protect privacy.

FIG. 7B illustrates another use case of the AI processing module 610 performing PII removal. As illustrated on the left side of FIG. 7B at 760, during the data collection process the one or more image capture devices 110 may record text 750 that includes PII. In the embodiment, the text 750 reveals the name and address of the data collection subject 705. To ensure that any such PII is removed from the captured images, the AI processing module 610 may cause the system 100 to perform the PII removal process as shown at 770. This results in the blurring or removal 780 of the text as shown at 790.

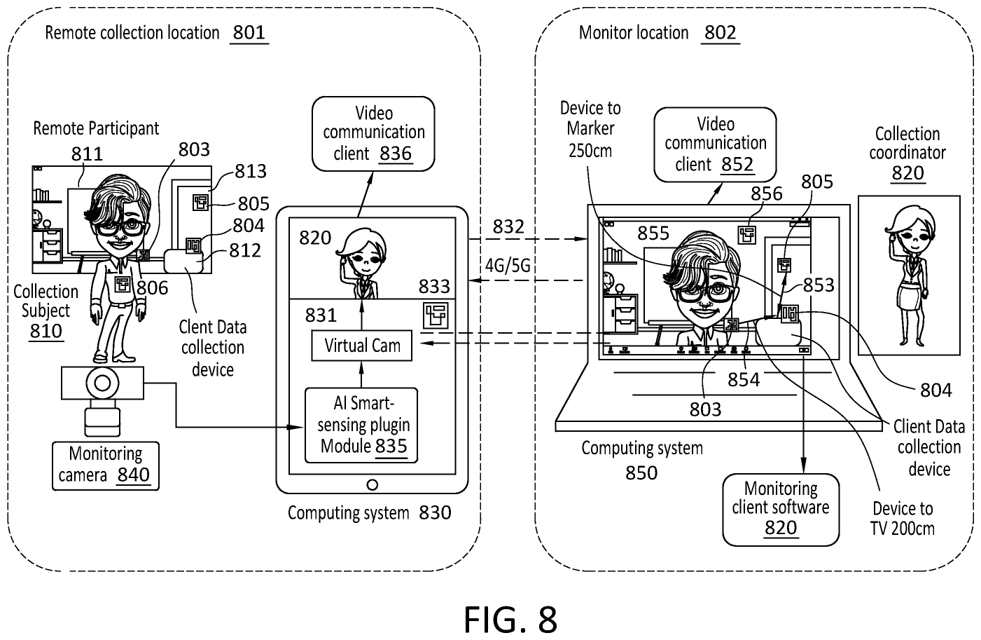

FIG. 8 illustrates an alternative embodiment of the system 100 that is configured more specifically for interaction between a collection subject and a collection coordinator who is remote from the collection subject. It will be appreciated, however, that the embodiment of FIG. 8 can include all the elements and functionality of the system 100 previously described in addition to the elements and functionality that will be explained in reference to FIG. 8. In particular, the embodiment of FIG. 8 may include the AI monitoring module 210 and the processing module 610. Thus, the embodiment of FIG. 8 may provide a user with the option of using the elements and functionality of the embodiments previously described and/or using the elements and functionality of FIG. 8 as will now be explained.

As illustrated, embodiment of FIG. 8 includes a collection subject 810, who may correspond to the data collection subjects previously described. In addition, the embodiment includes a collection coordinator 820. The collection subject may be located at a collection location 801 and the collection coordinator may be location at a monitor location 802. In the embodiment, the collection location 801 may be considered a remote collection location since it is remote from the location of the collection coordinator 820. For example, the remote collection location 801 may be in Dallas, Tex. while the monitor location may be in Seattle, Wash.

In the embodiment, the collection subject 810 may be provided with a computing system 830. In the embodiment, the computing system 830 may be a laptop computer or a tablet computing system, although other types of computing systems may also be used. In the embodiment, a monitoring camera 840, which may correspond to one of the image capture devices 110 discussed previously, may be integrated in the computing system 830. Having the monitoring camera 840 integrated with the computing system 830 advantageously helps in the setup of the data collection process as will be explained in more detail to follow. However, the monitoring camera 840 need not be integrated with the computing system 830 as there may instances where a detached camera may be beneficial. In still other embodiments, the computing system 830 may include the integrated monitoring camera 840 and may also be connected to one or more other image capture devices 110 as circumstances warrant.

The computing system 830 may include a processor such as the processor 170 including the AI monitoring module 210, a power source such as the power source 150, and a communication module such as the communication module 140. In some embodiments, the storage 105 may be included as part of the computing system 830. In some embodiments, the computing system 830 may include one or more of the sensors 120.

As illustrated, the remote location 801 may include various preprinted markers 803, 804, and 805. It will be appreciated that there may be any number of additional preprinted markers (not illustrated) included in the remote location 801 as circumstance warrant. In embodiments, the markers 803, 804, and 805 may be 1D or 2D barcodes or QR codes, or any other suitable type of marker and may correspond to the markers 283 and 284. In one embodiment, the collection coordinator 820 may provide the computing system 830, the various preprinted markers 803, 804, and 805, and perhaps one or more sensors 120 (if not included as part of the computing system 830) to the collection subject 810. The collection subject may then set-up the remote collection location 801 by placing the various preprinted markers 803, 804, and 805 (an any additional markers) in desired locations. For example, as shown in the embodiment, the marker 803 may be placed on a TV 811 and the marker 805 may be placed on a door or wall 813. In addition, the marker 804 may be placed on a data collection device 812, which may correspond to the data collection equipment 130 previously discussed. In the embodiments, the collection subject 810 may place a preprinted marker 806, which may be a 1D or 2D barcode or QR code, on himself or herself. The preprinted marker 806 may then be used in the same manner as the other markers to help determine a distance between the collection subject 810 and the other marked objects in the remote collection location 801.

In operation, the monitoring camera 840 is able to measure a distance between the various markers 803, 804, 805, and 806. For example, since the markers 803, 804, 805, 806 are preprinted, the computing system 830 may come preloaded with a size for each of the preprinted markers 803, 804, 805, and 806 before any data collection occurs. Using this preloaded size, the processor 170 of the computing system 830 are able to determine a distance between each of the various preprinted markers 803, 804, 805, and 806. In other words, the relative size of the various preprinted markers 803, 804, 805, and 806 will change as the markers are moved a further distance from the monitoring camera 840 and thus the distance can be determined since the computing system 830 knows the size of the preprinted markers 803, 804, 805, and 806.

It will be appreciated that in the embodiment where the preprinted markers are used, the monitoring camera 840 need not be a 3D depth camera. Rather, since the computing system 830 knows the size of the preprinted markers, the monitoring camera 840 may be a web camera or other camera integrated into the computing system 830 that only has to measure a distance between the various markers 803, 804, 805, and 806. Of course, in embodiments where the collection subject 810 does not wear the preprinted marker 806, or in embodiments where one or more of the preprinted markers 803, 804, and 805 are not provided, then the camera can be a 3D depth camera that is able to determine the distance between the data collection subject and the other markers in the manner previously described. In some embodiments, the computing system 830 will use both an integrated web camera and a 3D depth camera as circumstances warrant. Thus, the embodiments disclosed herein contemplate scenarios where the computing system 830 implements various kinds of cameras 840.

It will be appreciated that it may often be difficult for the collection subject 810 to set up the remote collection location 801 properly if he or she only has written instructions. In addition, it may also be difficult to set up the remote collection location 801 properly if the collection subject must interpret the instructions 310 and the warnings 320 generated by the AI monitoring module 210 as previously described. One solution to this problem would be for the collection coordinator 820 to come to the collection location 801 and personally direct the set-up of the collection location. However, if, as in the present embodiment, the collection location 801 is remote from the monitor location 802, such personal direction is not possible.

Accordingly, the embodiments provide for a real time video link between the collection subject 810 and the collection coordinator 820. As shown, the computing system 830 may include a UI 831, that may correspond to the UI 160. In addition, the computing system 830 may include an AI smart-sensing plugin module 835, which may be instantiated in the processor 170 and may be considered an example of an AI module of an AI system. In operation, the AI smart-sensing plugin module 835 operates the monitoring camera 840 and the other sensor hardware of the computing system and is configured to render a view of the remote collection location so that a distance between two of the markers can be determined. Further, the computing system 830 includes a video communication client 836. In operation, the video communication 836 is configured to access a video communications program or video conferencing platform such as Zoom by Zoom Video Communications, Microsoft Teams, Google Meetings, or any other suitable communications program or video conferencing platform incorporating both audio and visual capabilities and to use the video communication program or video conferencing platform to provide the data such as the distance between two of the markers to be provided to a computing system 850 of the collection coordinator 820 using a communication network 832. The communication network 832 may be a wireless network that uses the 4G or 5G communication standard (or any other reasonable standard) or it may be a wired network such as the Internet.

The computing system 850 of the collection coordinator 820 may include monitoring software 851 and a video communication client 852. In operation, the video communication client 852 is configured to access a video communications program or video conferencing platform such as Zoom by Zoom Video Communications, Microsoft Teams, Google Meetings, or any other suitable communications program or video conferencing platform incorporating both audio and visual capabilities that corresponds to the video communication program or video conferencing platform accessed by the video communication client 836 of the computing system 830. Thus, the computing system 830 and the computing system 850 are able to communicate in real time using the compatible video communication program or video conferencing platform.

In operation, the monitoring client software 851 is configured to render a view of the remote collection location 801 on a UI 855 of the computing system 850. As illustrated in FIG. 8, the UI 855 shows the collection subject 810, the TV 811, the data collection device 812, the door or wall 813, and the markers 803, 804, and 805. In addition, the monitoring client software 851 renders the data such as a distance between two of the markers in the view of the UI 855. For example, the distance 853 from the marker 804 of the data collection device 812 to the marker 805 of the door or wall 813 is shown as being 250 cm. Likewise, the distance 854 from the marker 804 of the data collection device 812 to the maker 803 of the TV 811 is shown as being 200 cm. Thus, the distances 853 and 854 are shown to the collection coordinator 820 in real time.

Accordingly, during set up of the remote collection location 801, the collection subject 810 and the collection coordinator 820 may communicate with each other in real time using their respective video communication clients. In addition, the collection coordinator 820 is able to monitor in real time as the collection subject 810 sets up the remote collection location 801. Since the collection coordinator 820 can see the distances between the markers in real time as described, he or she can direct the collection subject in real time to ensure that the distances between the markers are within the desired parameters discussed above. It will be appreciated that the data collection 810 may also use the user interface 831 using a voice command, one or more key buttons, a computer mouse, an Aruco marker, or a QR code as previously described to communicate with the computing system in addition to communicating with the collection coordinator. The user interface 831 may also be used in a flow control process as previously described.

In addition, once the actual data collection process begins, the collection coordinator 820 can continuously monitor the remote collection location and the collection subject. If the collection subject 810 moves too close too or too far away from the data collection device 812, this will be shown in the UI 855. At such time, the collection coordinator 820 can speak with the collection subject 810 in real time and ask the collection subject 810 to move as needed so that the distance is once again within the desired parameter. That is, the data collection subject may move in the manner discussed previously in relation to FIGS. 4A-4C and 5A-5C.

Although not illustrated, the UI 855 may show additional environmental conditions as measured by one or more sensors 120 in addition to or alternative to the distances that have been discussed. For example, in an embodiment a sensor 120 may measure the ambient noise of the remote collection location 801 or may measure the lighting of the remote collection location 801. These measures values may then be shown in real time on the UI 855 to the collection coordinator 820. If the measured values are outside of desired ranges, the collection coordinator 820 can ask the collection subject 810 to make changes as needed so that the environmental conditions are within the desired ranges.

In some embodiments, the UI 831 of the computing system 830 may show a QR code 833 that is generated by the computing system 850. In operation, the collection subject 810 can scan the QR code 833 and can then be taken to a remote website where the collection coordinator 820 may provide further instructions and information related to the data collection process as needed to the collection subject since it may not be possible to provide all necessary information during the video communication. In addition, the QR code 833 may provide additional security as it can be used by the collection subject to verify that the video coordinator is a valid coordinator. In other words, if the QR code 833 is valid, then the collection subject can have confidence that the collection coordinator and the data collection process are valid.

Likewise, in some embodiments the UI 855 may show a QR code 856 that is viewable by the collection coordinator 820 and generated by the computing system 830. In operation, the QR code 856 may be used to by the collection coordinator to validate that he or she is actually viewing the remote collection location 801. For example, there may be instances where a collection subject 810 may try to spoof the remote location 801 so that the collection subject does not need to follow the health protocols and/or the environmental protocols. If the QR code 856 is valid, then the collection coordinator can have confidence he or she is viewing the remote collection location 801 in real-time. Further, the QR code 856 may lead the collection coordinator to a website where the collection subject is able to provide further information as needed.

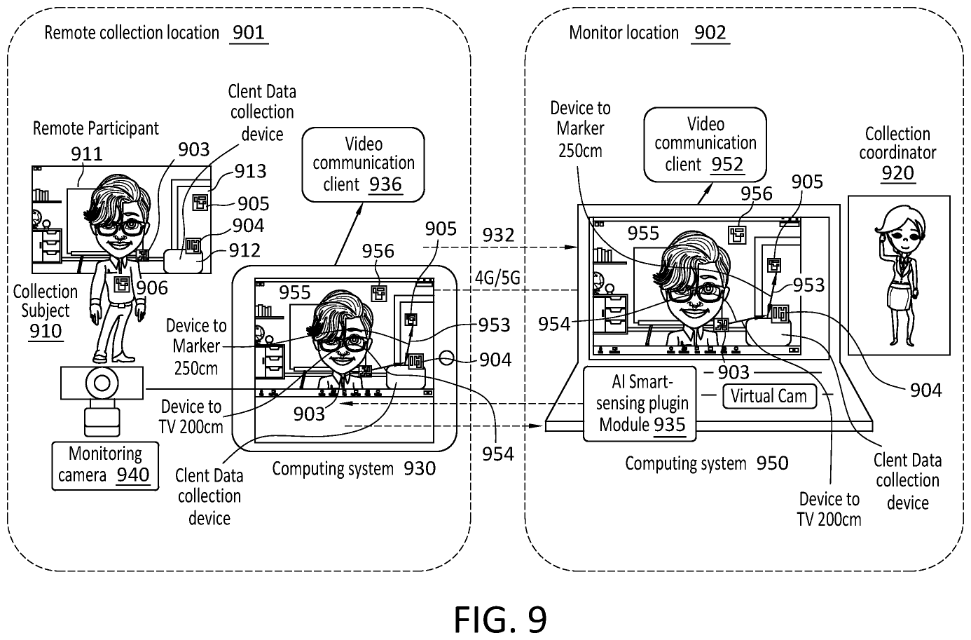

FIG. 9 illustrates an alternative embodiment of the system 100 that is configured more specifically for interaction between a collection subject and a collection coordinator who is remote from the collection subject. It will be appreciated, however, that the embodiment of FIG. 9 can include all the elements and functionality of the system 100 previously described in addition to the elements and functionality that will be explained in reference to FIG. 9. In particular, the embodiment of FIG. 9 may include the AI monitoring module 210 and the AI processing module 610. Thus, the embodiment of FIG. 9 may provide a user with the option of using the elements and functionality of the embodiments previously described and/or using the elements and functionality of FIG. 9 as will now be explained.

As illustrated, the embodiment of FIG. 9 includes a collection subject 910, who may correspond to the data collection subjects previously described. In addition, the embodiment includes a collection coordinator 920. The collection subject may be located at a collection location 901 and the collection coordinator may be located at a monitor location 902. In the embodiment, the collection location 901 may be considered a remote collection location since it is remote from the location of the collection coordinator 920. For example, the remote collection location 901 may be in Dallas, Tex. while the monitor location may be in Seattle, Wash.

In the embodiment, the data collection coordinator 920 may be provided with a computing system 950, which may be any reasonable computing system such as a laptop computer. The computing system 950 may include the processor 170 that instantiates the AI monitoring module 210 and the AI processing module 610 as previously discussed. The computing system 950 may also include a power source such as the power source 150, and a communication module such as the communication module 140. In some embodiments, the storage 105 may be included as part of the computing system 950.

In the embodiment, the collection subject 910 may be provided with a computing system 930. The computing system 930 may be a laptop computer or a tablet computing system, although other types of computing systems may also be used. In this embodiment, the computing system 930 may not include the AI monitoring module 210 and the AI processing module 610 so as to save on the cost of the computing system, although there may be embodiments where the AI monitoring module 210 and the AI processing module 610 are included in the computing system 930. Thus, in this embodiment the processing of the data by the AI modules will typically occur only in the computing system 950 of the data collection coordinator 920.

The computing system 930 includes a video communication client 936, which may be part of the communication module 140 of the computing system. In operation, the video communication client 936 is configured to access a video communications program or video conferencing platform such as Zoom by Zoom Video Communications, Microsoft Teams, Google Meetings, or any other suitable communications program or video conferencing platform incorporating both audio and visual capabilities and to use the video communication program or video conferencing platform to stream video to the computing system 950 of the collection coordinator 920 using a communication network 932. The communication network 932 may be a wireless network that uses the 4G or 5G communication standard (or any other reasonable standard) or it may be a wired network such as the Internet.

The computing system 950 of the collection coordinator 920 may include a video communication client 952 and an AI smart-sensing plugin module 935, which may be instantiated in the processor 170 and may be considered an example of an AI module of an AI system. In operation, the video communication client 952 is configured to access the video communications program or video conferencing platform such as Zoom by Zoom Video Communications, Microsoft Teams, Google Meetings, or any other suitable communications program or video conferencing platform incorporating both audio and visual capabilities that corresponds to the video communication program or video conferencing platform accessed by the video communication client 936 of the computing system 930. Thus, the computing system 930 and the computing system 950 are able to communicate in real time using the compatible video communication program or video conferencing platform that is supported by both of the computing systems.

In the embodiment, a monitoring camera 940, which may correspond to one of the image capture devices 110 discussed previously, may be integrated in the computing system 930. That is, the monitoring camera 940 may be the camera that is built into many laptop computers and tablet computers. Having the monitoring camera 940 integrated with the computing system 930 advantageously helps in the setup of the data collection process as will be explained in more detail to follow. However, the camera 940 need not be integrated with the computing system 930 as there may instances where a detached camera may be beneficial. In still other embodiments, the computing system 930 may include the integrated camera 940 and may also be connected to one or more other image capture devices 110 as circumstances warrant.

As illustrated, the remote location 901 may include various preprinted markers 903, 904, and 905. It will be appreciated that there may be any number of additional preprinted markers (not illustrated) included in the remote location 901 as circumstance warrant. In embodiments, the markers 903, 904, and 905 may be 1D or 2D barcodes or QR codes, or any other suitable type of marker and may correspond to the markers 283 and 284. In one embodiment, the collection coordinator 920 may provide the various preprinted markers 903, 904, and 905, and perhaps one or more sensors 120 (with display) to the collection subject 910.

The collection subject 910 may then set-up the remote collection location 901 by placing the various preprinted markers 903, 904, and 905 (and any additional markers) in desired locations. For example, as shown in the embodiment, the marker 903 may be placed on a TV 911 and the marker 905 may be placed on a door or wall 913. In addition, the marker 904 may be placed on a data collection device 912, which may correspond to the data collection equipment 130 previously discussed. In the embodiments, the collection subject 910 may place a preprinted marker 906, which may be a 1D or 2D barcode or QR code, on himself or herself. The preprinted marker 906 may then be used in the same manner as the other markers to help determine a distance between the collection subject 910 and the other marked objects in the remote collection location 901.

In operation, the monitoring camera 940 is able to capture a video of the various markers 903, 904, 905, and 906 and to stream the video to the computing system 950. Since the markers 903, 904, 905, 906 are preprinted and thus have a predefined size, the computing system 950 may store the predefined size for each of the preprinted markers 903, 904, 905, and 906 before any data collection occurs. Using this stored size, the processor 170 of the computing system 950 is able to determine a distance between each of the various preprinted markers 903, 904, 905, and 906 based on the video provided by the monitoring camera 940. In other words, the relative size of the various preprinted markers 903, 904, 905, and 906 will change as the markers are moved a further distance from the monitoring camera 940 and thus the distance can be determined since the computing system 950 knows the size of the preprinted markers 903, 904, 905, and 906.

It will be appreciated that in the embodiment where the preprinted markers are used, the monitoring camera 940 need not be a 3D depth camera. Rather, since the computing system 950 knows the size of the preprinted markers, the monitoring camera 940 may be a web camera or other camera integrated into the computing system 930 that only has to capture a video the various markers 903, 904, 905, and 906.

It will also be appreciated that it may often be difficult for the collection subject 910 to set up the remote collection location 901 properly if he or she only has written instructions. In addition, it may also be difficult to set up the remote collection location 901 properly if the collection subject must interpret the instructions 310 and the warnings 320 generated by the AI monitoring module 210 as previously described. One solution to this problem would be for the collection coordinator 920 to come to the collection location 901 and personally direct the set-up of the collection location. However, if, as in the present embodiment, the collection location 901 is remote from the monitor location 902, such personal direction is not possible.

Accordingly, the embodiments provide for the compatible video communication program or video conferencing platform that is supported by both of the computing systems of the collection subject 910 and the collection coordinator 920 to stream data between the collection subject 910 and the collection coordinator 920. In operation, the AI smart-sensing plugin module 935 of the computing system 950 operates the video stream from computing system 930 and causes data, such as a distance between two of the markers, to be determined. In addition, the AI smart-sensing plugin module 935 is configured to render a view of the remote collection location 901 and feed the video stream back to the video communication client 936, so that the collection subject 910 can see the measured distance. As illustrated in FIG. 9, the feedback video stream shows the collection subject 910, the TV 911, the data collection device 912, the door or wall 913, and the markers 903, 904, and 905. In addition, the AI smart-sensing plugin module 935 renders the data such as a distance between two of the markers is in the view of the video communication client 936. For example, a distance 953 from the marker 904 of the data collection device 912 to the marker 905 of the door or wall 913 is shown as being 250 cm. Likewise, the distance 954 from the marker 904 of the data collection device 912 to the maker 903 of the TV 911 is shown as 200 cm. Thus, the distances 953 and 954 are shown to the data collection subject 910 and the collection coordinator 920 in real time.

Accordingly, during set up of the remote collection location 901, the collection subject 910 and the collection coordinator 920 may communicate with each other in real time using their respective video communication clients. In addition, the collection coordinator 920 is able to monitor in real time as the collection subject 910 sets up the remote collection location 901. Since the collection coordinator 920 can see the distances between the markers in real time as described, he or she can direct the collection subject in real time to ensure that the distances between the markers are within the desired parameters discussed above.

In addition, once the actual data collection process begins, the collection coordinator 920 can continuously monitor the remote collection location and the collection subject. If the collection subject 910 moves too close too or too far away from the data collection device 912, this will be shown in the video feedback. At such time, the collection coordinator 920 can speak with the collection subject 910 in real time and ask the collection subject 910 to move as needed so that the distance is once again within the desired parameters. That is, the data collection subject may move in the manner discussed previously in relation to FIGS. 4A-4C and 5A-5C.

Although not illustrated, the video feedback may show additional environmental conditions as measured by one or more sensors 120 in addition to or alternative to the distances that have been discussed. For example, in an embodiment a sensor 120 may measure the ambient noise of the remote collection location 901 or may measure the lighting of the remote collection location 901 and show the measurement result through an LED display. That is, in the embodiment of FIG. 9 the sensors 120 may be placed in various spots in the remote collection location 901 and may all include LED screens of a size sufficient to be captured by the monitoring camera 940 and provided to the computing system 950 over the video stream. These measures values may then be read in real time to the collection coordinator 920 from the video stream. If the measured values are outside of desired ranges, the collection coordinator 920 can ask the collection subject 910 to make changes as needed so that the environmental conditions are within the desired ranges.

In some embodiments, the AI smart-sensing plugin module 935 of the computing system 950 may show a QR code 956 in the video feedback that is generated by the computing system 950. In operation, the collection subject 910 can scan the QR code 956 and can then be taken to a remote website where the collection coordinator 920 may provide further instructions and information related to the data collection process as needed to the collection subject since it may not be possible to provide all necessary information during the video communication. In addition, the QR code 956 may provide additional security as it can be used by the collection subject to verify that the video coordinator is a valid coordinator. In other words, if the QR code 956 is valid, then the collection subject 910 can have confidence that the collection coordinator 920 and the data collection process are valid.

Not necessarily all such objects or advantages may be achieved under any embodiment of the disclosure. Those skilled in the art will recognize that the disclosure may be embodied or conducted to achieve or optimize one advantage or group of advantages as taught without achieving other objects or advantages as taught or suggested.

The skilled artisan will recognize the interchangeability of various components from different embodiments described. Besides the variations described, other known equivalents for each feature can be mixed and matched by one of ordinary skill in this art to construct or use AI monitoring system for data collection using the principles of the present disclosure.

Although the AI monitoring system for data collection has been disclosed in certain preferred embodiments and examples, it therefore will be understood by those skilled in the art that the present disclosure extends beyond the disclosed embodiments to other alternative embodiments and/or uses of the AI monitoring system for data collection and method for using the same and obvious modifications and equivalents. It is intended that the scope of the present AI monitoring system for data collection disclosed should not be limited by the disclosed embodiments described above, but should be determined only by a fair reading of the claims that follow.

1. An Artificial Intelligence (AI) system for monitoring and/or processing a data collection process involving one or more data collection subjects, the system comprising:
an AI module, the AI module configured to instantiate one or more of the following:
an AI monitoring module, the AI monitoring module configured to instantiate one or more of the following:
a health protocol check submodule configured to check if one or more health safety rules and protocols are being satisfied by the one or more data collection subjects during the data collection process;
an environmental condition check submodule configured to check if the environmental conditions of the test environment satisfy data collection rules or protocols are being satisfied by the one or more data collection subjects during the data collection process;
a data collection configuration check submodule configured to check if the data collection conditions satisfy the data collection rules or protocols are being satisfied by the one or more data collection subjects during the data collection process; and
an AI processing module configured to remove any Personal Identification Information (PII) of the one or more data collection subjects from the data collected during the data collection process.

2. The AI system of claim 1, wherein the system comprises a one or more image capture devices that capture images of the one or more data collection subjects and the environmental conditions of a location where the data collection process occurs.

3. The AI system of claim 2, wherein the one or more image capture devices comprise a 3D depth camera.

4. The AI system of claim 2, wherein the one or more image capture devices comprise a camera that is integrated onto a computing system or tablet computing system.

5. The AI monitoring system of claim 1, wherein the AI module is configured to apply the at least one AI algorithm to a captured image or video to determine a distance between at two data collection subjects.

6. The AI monitoring system of claim 1, wherein the AI module is configured to apply the at least one AI algorithm to a captured image or video to determine a distance between the at least one data collection subject and one or more data collection equipment.

7. The AI monitoring system of claim 1, wherein the system comprises one or more sensors that measure one or more health aspects of the one or more data collection subjects and/or measures one or more physical properties of the location where the data collection process is occurring.

8. The AI system of claim 1, wherein the system comprises one or more sensors that measure a time that the data collection process occurs and/or a location of the data collection process.

9. The AI system of claim 1, wherein the AI processing module is configured to blur or alter the data collected to remove any PII.

10. A method for an Artificial Intelligence (AI) system to monitor and/or process a data collection process, the method comprising:
sending one or more instructions to one or more data collection subjects, the one or more instructions indicating one or more health safety rules and protocols and/or one or more data collection rules or protocols that are to be satisfied by one or more data collection subjects during the data collection process;
sending a warning message to the one or more data collection subjects when it is determined that the one or more data collection subjects are violating or more of the health safety rules and protocols and/or one or more data collection rules or protocols; and
receiving feedback from the one or more data collection subjects that the violation has been corrected.

11. The method according to claim 10, wherein the one or more instructions are sent to a user interface of a computing system at a location of the one or more data collection subjects.

12. The method according to claim 10, wherein the feedback comprises user input that is input by the one or more data collection subjects into a user interface of a computing system at a location of the one or more data collection subjects.

13. The method according to claim 12, wherein the feedback is automatic feedback comprising having the one or more data collection subjects move to comply with the warning to correct the violation of the more of the health safety rules and protocols and/or one or more data collection rules or protocols.

14. The method according to claim 10, wherein the feedback is automatic feedback comprising having the one or more data collection subjects move one or more data collection equipment to comply with the warning to correct the violation of the more of the health safety rules and protocols and/or one or more data collection rules or protocols.

15. An Artificial Intelligence (AI) system for monitoring and/or processing a data collection process at a data collection location involving one or more data collection subjects, the system comprising:
an AI module, the AI module configured to instantiate one or more of the following:
an AI monitoring module, the AI monitoring module configured to instantiate one or more of the following:
a health protocol check submodule configured to check if one or more health safety rules and protocols are being satisfied by the one or more data collection subjects during the data collection process;
an environmental condition check submodule configured to check if the environmental conditions of the test environment satisfy data collection rules or protocols are being satisfied by the one or more data collection subjects during the data collection process;
a data collection configuration check submodule configured to check if the data collection conditions satisfy the data collection rules or protocols are being satisfied by the one or more data collection subjects during the data collection process;
an AI processing module configured to remove any Personal Identification Information (PII) of the one or more data collection subjects from the data collected during the data collection process;
an AI smart-sensing plugin module configured to render information collected by the AI module in real-time on a computing system such that a user of the computing system is able to receive real-time input from the data collection location; and
a video communication client configured to access a video communication program or video conferencing platform and to communicate using the video communication program or video conferencing platform.

16. The AI system of claim 15, wherein the AI module is located on a computing system of the one or more data collection subjects.

17. The AI system of claim 15, wherein the AI module is located on a computing system of a data collection coordinator that communicates with the one or more data collection subjects using the video communication program or video conferencing platform.

18. The AI system of claim 15, wherein the AI module is located on a computing system of a data collection coordinator that communicates with the one or more data collection subjects using the video communication program or video conferencing platform and one a computing system of the one or more data collection subjects.

19. The AI monitoring system of claim 15, wherein the one or more data collection subjects communicate with a remote data collection coordinator using the video communication program or video conferencing platform.

20. The AI system of claim 15, wherein an integrated camera of a computing system of the one or more data collection subjects sends a video feed to a computing system of a remote data collection coordinator using the video communication program or video conferencing platform.
